(19) United States
(12) Patent Application Publication
(10) Pub. No.: US 2025/0168345 A1
(43) Pub. Date: May 22, 2025

(54) REDUCING THE AMORTIZATION GAP IN END-TO-END MACHINE LEARNING IMAGE COMPRESSION

(71) Applicant: InterDigital CE Patent Holdings, SAS, Paris (FR)

(72) Inventors: Muhammet Balcilar, Betton (FR); Bharath Bhushan Damodaran, Vannes (FR); Pierre Hellier, Thorigne-Fouillard (FR); Anne Lambert, Saint-Aubin-d’Aubigné (FR)

(73) Assignee: InterDigital CE Patent Holdings, SAS, Paris (FR)

(21) Appl. No.: 18/838,532

(22) PCT Filed: Feb. 15, 2023
(86) PCT No.: PCT/EP2023/053724

§ 371 Date: Aug. 14, 2024

(30) Foreign Application Priority Data
Feb. 15, 2022 (EP) 22305167.3
May 9, 2022 (EP) 22305685.4

(51) Int. Cl. H04N 19/13; H04N 19/172; H04N 19/91

(52) U.S. Cl. CPC H04N 19/13; H04N 19/172; H04N 19/91

(57) ABSTRACT

Systems, methods, and instrumentalities are disclosed herein for reducing the amortization gap in end-to-end image compression and/or video compression. In examples, a video decoder may obtain an entropy model indication in video data. Based on the entropy model indication, the decoder may determine an entropy model to use for decoding a current picture. The current picture may be decoded based on the determined entropy model. In examples, the entropy model indication may indicate whether to use an updated entropy model or a prior entropy model for decoding the current picture. In examples, the entropy model indication may indicate an updated entropy model or a learned entropy model to use for decoding the current picture.

### CROSS-REFERENCE TO RELATED APPLICATIONS

This application claims the benefit of European Patent Application 22305685.4, filed May 9, 2022, and European Patent Application 22305167.3, filed Feb. 15, 2022, the disclosures of which are incorporated herein by reference in their entireties.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed herein for reducing the amortization gap in end-to-end image compression and/or video compression.

In examples, a video decoder may obtain an entropy model indication in video data. Based on the entropy model indication, the decoder may determine an entropy model to use for decoding a current picture. The current picture may be decoded based on the determined entropy model. In examples, the entropy model indication may indicate whether to use an updated entropy model or a prior entropy model for decoding the current picture. In examples, the entropy model indication may indicate an updated entropy model or a learned entropy model to use for decoding the current picture.

Based on the entropy model indication indicating to use an updated entropy model for decoding the current picture, the decoder may obtain at least one updated entropy model parameter associated with the updated entropy model based on the video data. The current picture may be decoded based on the at least one updated entropy model parameter associated with the updated entropy model. Based on the entropy model indication indicating to use a prior entropy model for decoding the current picture, the prior entropy model may be obtained. The current picture may be decoded based on the prior entropy model. Based on the entropy model indication indicating to use a learned entropy model for decoding the current picture, the learned entropy model may be obtained. The current picture may be decoded based on the learned entropy model. Based on the entropy model indication indicating to use a prior entropy model for decoding the current picture, previous entropy model parameters associated with a previous picture may be obtained. The current picture may be decoded based on the previous entropy model parameters associated with the previous picture.

In examples, a video encoder may determine an entropy model for encoding a current picture. The current picture may be encoded based on the determined entropy model. The encoder may include an indication of the determined entropy model in video data. In examples, the encoder may select between a prior entropy model and an updated model for encoding the current picture. Based on determining to use an updated entropy model for encoding the current picture, the encoder may set the indication of the determined entropy model to indicate that the updated entropy model is used for the current picture. The encoder may include an indication of at least one updated entropy model parameter associated with the updated entropy model in the video data.

In examples, the encoder may obtain a latent representation of the current picture. An updated entropy model may be derived based on the latent representation. The encoder may select between the updated entropy model and a learned entropy model for encoding the current picture based on a gain associated with using the updated entropy model and a cost associated with indicating the updated entropy model in the video data.

In examples, the encoder may select between a learned entropy model and an updated entropy model for encoding the current picture. Based on selecting the learned entropy model for encoding the current picture, the encoder may set the entropy model indication to indicate that the learned entropy model is used for the current picture.

In examples, the encoder may obtain a latent representation of the current picture. An updated entropy model may be derived based on the latent representation. The encoder may select between the updated entropy model and a learned entropy model for encoding the current picture. The updated entropy model may include updated entropy model parameters. The updated entropy model parameters may be quantized based on the derivation of the updated entropy model. The encoder may calculate a gain associated with using the updated entropy model parameters and a cost associated with indicating the updated entropy model parameters in the video data. Based on the calculation, the encoder may select between the updated entropy model and the prior entropy model for encoding the current picture.

These examples may be performed by a video processing device with a processor. The device may be an encoder or a decoder. These examples may be performed by a computer program product which is stored on a non-transitory computer readable medium and includes program code instructions. These examples may be performed by a computer program comprising program code instructions. These examples may be performed by a bitstream comprising information representative of end-to-end video compression and/or image compression.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 15A according to an embodiment.

FIG. 1C is a system diagram illustrating an example radio access network (RAN) and an example core network (CN) that may be used within the communications system illustrated in FIG. 15A according to an embodiment.

FIG. 1D is a system diagram illustrating a further example RAN and a further example CN that may be used within the communications system illustrated in FIG. 15A according to an embodiment.

FIG. 2 illustrates an example of an apparatus for compressing, encoding or decoding video using the aforementioned examples.

FIG. 3 illustrates an example video encoder.

FIG. 4 illustrates an example video decoder.

FIG. 5 illustrates an example of a system in which various aspects and examples may be implemented.

FIG. 6 illustrates examples of learned probability mass functions, the reparameterization probability mass functions, and normalized frequencies for an image's selected latent under factorized and hyperprior entropy models respectively.

FIG. 7 illustrates experimental results on image test sets for fully factorized entropy model.

FIG. 8 illustrates experimental results on image test sets for hyperprior entropy model.

FIG. 9 illustrates an example for encoding video data.

FIG. 10 illustrates an example for decoding video data.

FIG. 11 illustrates examples of learned probability mass function (pmf) tables in a model, pmf after reparameterization in a model, and normalized frequencies.

FIG. 12 example entropy model indications that may indicate whether to use a prior entropy model (e.g., PMF table) or an updated entropy model (e.g., PMF table).

FIG. 13 illustrates an example for encoding with factorized entropy.

FIG. 14 illustrates an example for decoding for factorized entropy.

FIG. 15 illustrates an example of amortization gaps and savings relative to the total file size of three other neural video compression examples for 16 frame length video sequence compression on 7 videos in UVG dataset under different reconstruction quality.

### DETAILED DESCRIPTION

A more detailed understanding may be had from the following description, given by way of example in conjunction with the accompanying drawings.

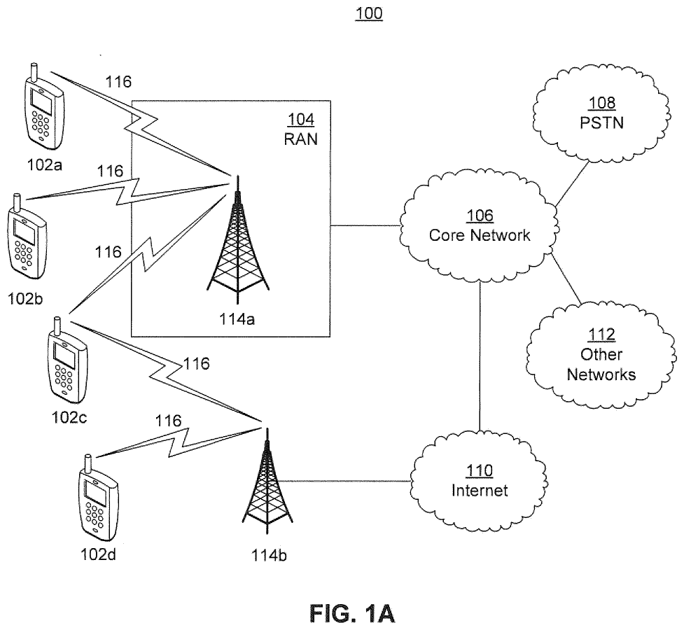

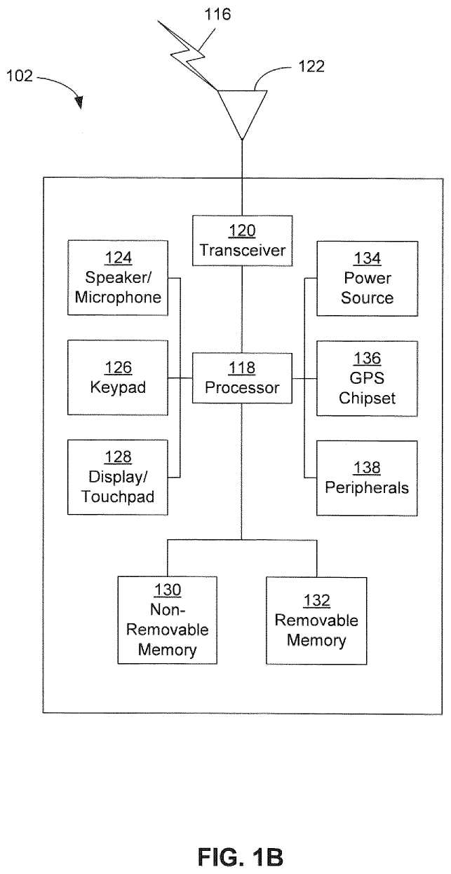

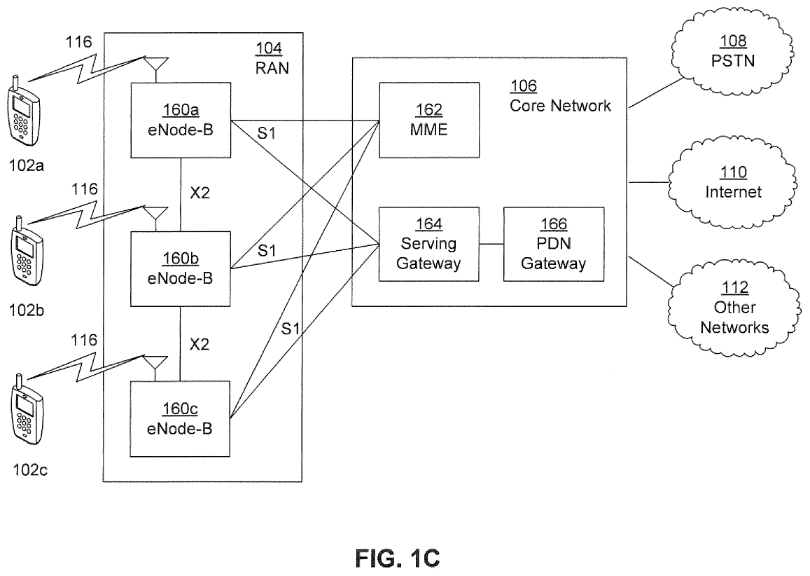

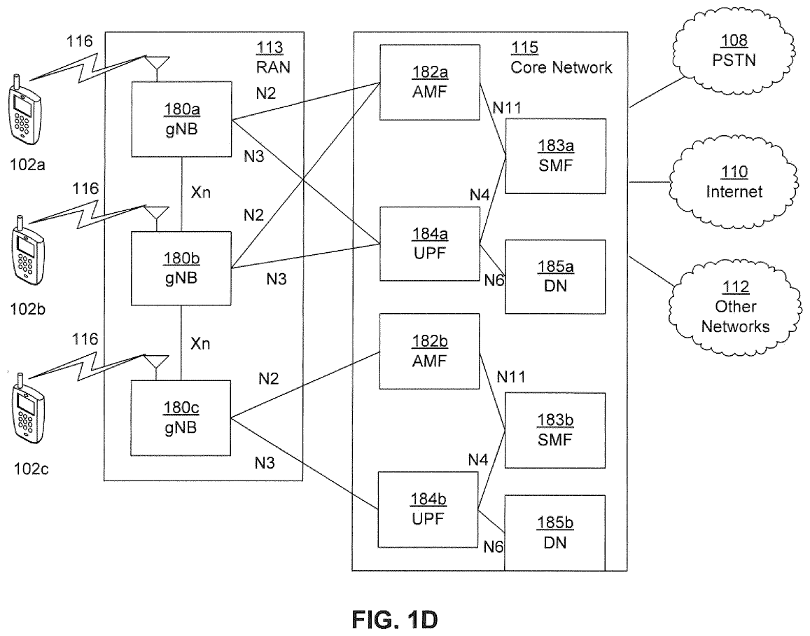

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. As suggested above, the processor 118 may include a plurality of processors. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

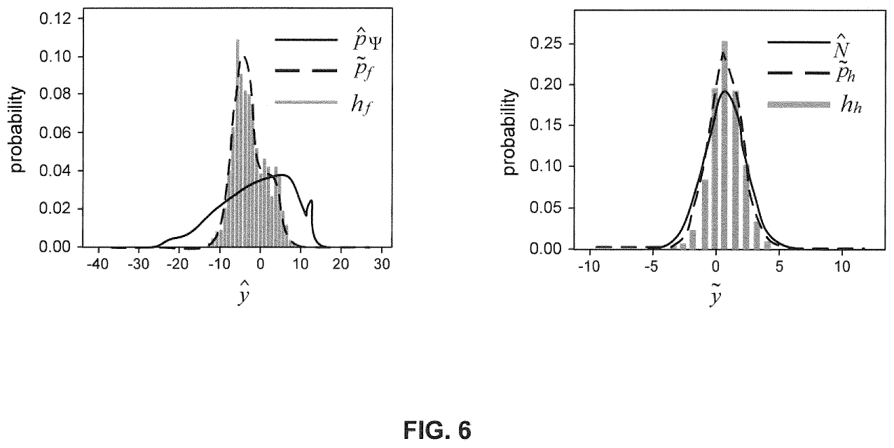

The aspects described and contemplated in this application may be implemented in many different forms. FIGS. 6-15 described herein may provide some examples, but other examples are contemplated. The discussion of FIGS. 6-15 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

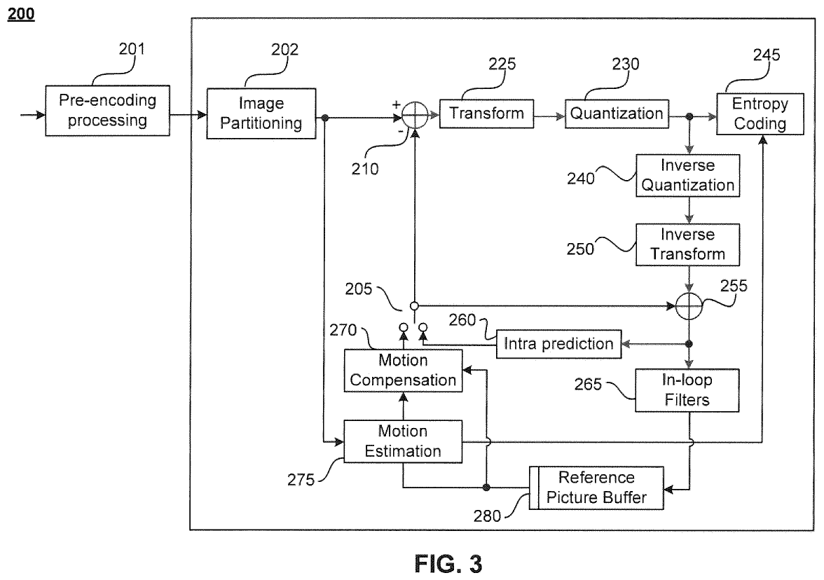

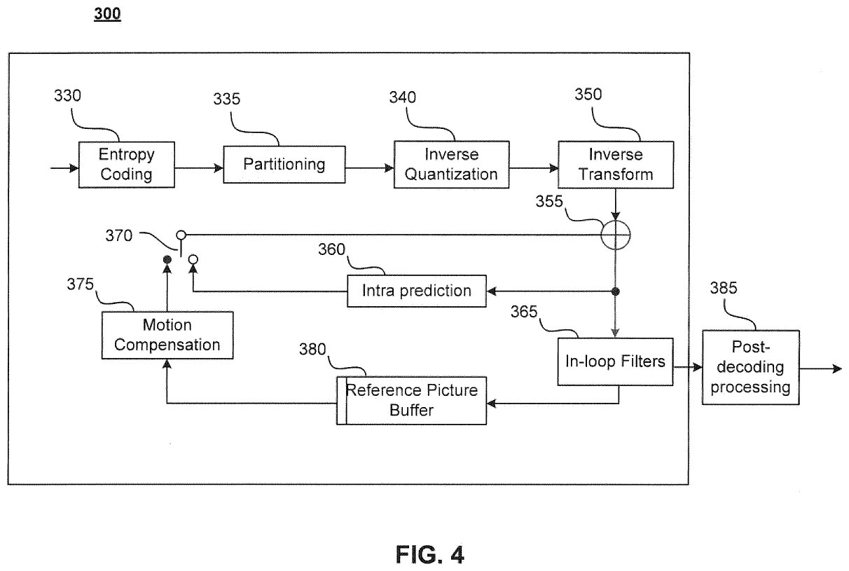

Various methods and other aspects described in this application may be used to modify modules, for example, decoding modules, of a video encoder 200 and decoder 300 as shown in FIG. 3 and FIG. 4. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as bits, bit depth, etc. These and other specific values are for purposes of describing examples and the aspects described are not limited to these specific values.

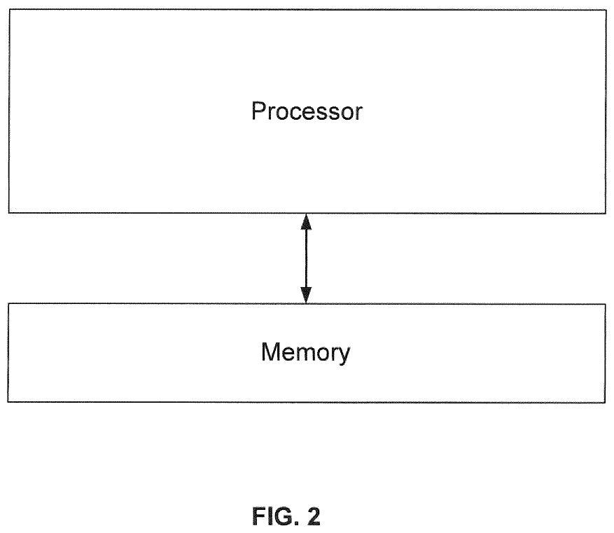

FIG. 2 illustrates an example of an apparatus for compressing, encoding or decoding video using the aforementioned examples. The apparatus includes a processor and may be interconnected to a memory through at least one port. Both the processor and memory may (e.g., may also) have one or more additional interconnections to external connections. The processor may (e.g., may also) be configured to either insert or receive information in a bitstream and, either compressing, encoding, or decoding using the aforementioned examples.

FIG. 3 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 4 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

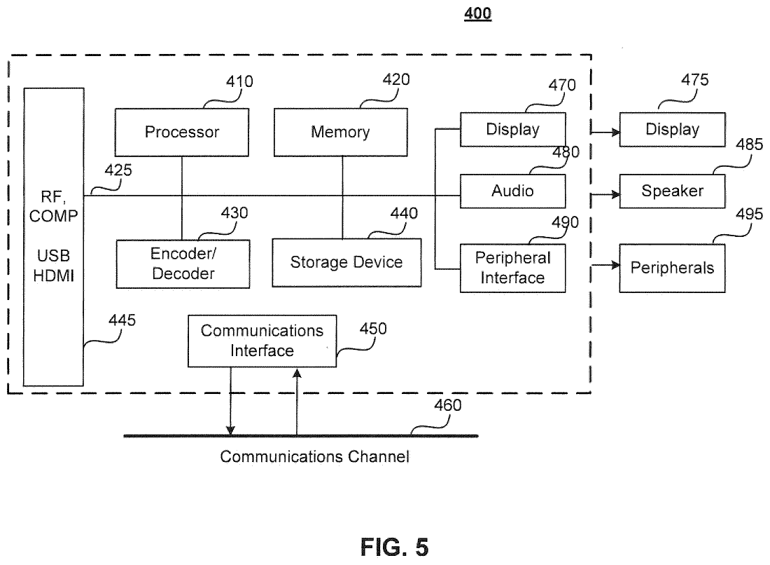

FIG. 5 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 5, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth© network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, determining that region dependence mode is enable for a picture, for a block in a region, determining whether a neighboring block is available for intra prediction based on a location of the neighboring block relative to the region, decoding the block based on the determination of whether the neighboring block is available for intra prediction, etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining to enable a region dependence mode for a picture, for a block in a region, determining whether a neighboring block is available for intra prediction based on a location of the neighboring block relative to the region, and encoding the block based on the determination of whether the neighboring block is available for intra prediction, etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” may (e.g., may also) be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

These examples may be performed by a device with at least one processor. The device may be an encoder or a decoder. These examples may be performed by a computer program product which is stored on a non-transitory computer readable medium and includes program code instructions. These examples may be performed by a computer program comprising program code instructions.

Examples of end-end trainable models are provided herein. End-to-end trainable models may be about to exceed the performance of the traditional handcrafted compression techniques on videos and images. The examples may learn a non-linear transformation into latent space, jointly with an entropy model of the latent distribution. These examples may enforce the latent to follow some prior distributions. Since the prior distributions may be learned by amortizing its parameters over the training set (e.g., entire training set), the prior distributions may not fit (e.g., exactly) on every single instance. The prior distributions may damage the compression performance by enlarging the bitstream.

End-to-end deep compression examples may as a special case of Variational Autoencoder (VAE) model, where the approximate posterior distribution may have uniform distribution centered to the encoder's outputs (e.g., latents) at a train time (e.g., which may also be a continuous relaxation of quantization of the latents) and may have trainable prior distributions. Minimizing the evidence lower bound (ELBO) of this special VAE may be equivalent to minimizing jointly the mean square error (MSE) of reconstruction and the entropy of latents with respect to (w.r.t.) to the prior distributions. At test time, these codecs may encode quantized latents in lossless manner with respect to prior distributions into a bit-stream. It may be performed by (e.g., any) entropy encoder such as range coding. Since the decoder and the prior distributions may be shared with the receiver in advance (e.g., or prior distributions may be reconstructed by side information), quantized latents may be read back from bitstream by (e.g., any) entropy decoder (e.g., range decoder). Quantized latents may (e.g., may then) reconstruct the input data.

The examples may differ by the modelling of prior distributions, such as by least: using either a fully factorized, a zero mean gaussian, a gaussian, or mixture of gaussian, where the latter may predict prior distributions by an autoregressive manner. Prior distributions models may be learned by amortizing its parameters over the training set (e.g., entire training set), which may make them sub-optimal for a given specific data instance. This may be referred to as the amortization gap. Examples may enforce that the latent of the given instance that obeys the prior distributions. These examples may not (e.g., may not need to) update on the receiver side but may have limited gain. Examples may modify the prior distributions to better fit the given instance's latents. These examples may update the encoder/decoder. These examples may update the entropy model. These examples may result in more gain, at the (e.g., additional) cost of transmitting these updates to the receiver. Post-training may be performed to overfit on a given data instance, which may increase the encoding time. The amortization gap of entropy model may be defined in the compressing perspective. The amortization gap of some recent neural image compression model over benchmark datasets may be reported. Examples to adjust the prior distributions to fit on given data's latent may be provided. Post-training may not be needed thus there may be no burden of computation complexity. Almost at least 1% of the file size for state-of-the-art neural image compressing model may be saved without any effect on reconstruction quality and may not need high computational complexity in encoding time.

In end-to-end image compression, the encoder y=gₐ(x; φ) may be parameterized by φ transforming the input x∈R^{n×n×3} into the low dimensional latent y∈R^{m×m×s}, where it may be quantized by Q(·) to obtain the discrete latents ŷ=Q(y). The quantized latents may be compressed losslessly by the entropy coder using p_{f}(ŷ|Ψ) in fully-factorized model. However, if the entropy model of the latent y is conditioned with side information to account for the spatial dependencies, side information z=hₐ(y; Φ)(and its quantization \hat{z}=Q(z) may be learned and the quantized latent ŷ may be coded with the condition entropy model pₕ(ŷ|\hat{z}), and \hat{z} may be coded with p_{f}(\hat{z}|Ψ). The decoder \hat{x}=gₛ(ŷ; θ) may convert the latents backs to the reconstructed image \hat{x}. The parameters of ga, gs, pf, ph may be obtained by minimizing the following rate-distortion loss function:

$$ℒ = {𝔼}_{{x ∼ {p}_{x}}_{ϵ ∼ U}} [ - log ( {p}_{h} ( \hat{y} \vert \hat{z} , Θ ) ) - log ( {p}_{f} ( \hat{z} \vert Ψ ) ) + λ \cdot d ( x , \hat{x} ) ] \qquad ( 1 )$$

Here, d(·, ·) may be any distortion loss such as MSE, λ may be the tradeoff parameter to control compression ratio and quality, Q(·) may be a continuous relaxation in train time as Q(x)=x+ϵ, ϵ˜U(−0.5, 0.5). The equation (1) may be a hyperprior entropy model, and if the latent entropy model is not conditioned with the side information, may be known as a fully factorized model. In factorized entropy model (second term in (1)), each k×k slices of side latent may have its own trainable cumulative distribution function (cdf) in an entropy model shown by p̅_{Ψ}^{(c)}(·) c=1 . . . f, and probability mass function (PMF) for a given value of x may be derived from its cdf as \hat{p}_{Ψ}^{(c)}(x)=p̅_{Ψ}^{(c)}(x+0.5)−p̅_{Ψ}^{(c)}(x−0.5). Thus, an entropy model may apply as follows:

$${p}_{f} ( \hat{z} \vert Ψ ) = {\prod }_{c = 1}^{f} {\prod }_{i , j = 1}^{k , k} {\hat{p}}_{Ψ}^{( c )} ( {\hat{z}}_{i , j , c} ) \qquad ( 2 )$$

In hyperprior entropy (first term in (1)), each latent point may be modeled as a 1d gaussian distribution and its PMF may be \hat{N}(x; μ, σ)=N̅(x+0.5; μ, σ)−N̅(x−0.5; μ, σ). The hyperprior entropy model may be written pₕ(ŷ|\hat{z}, Θ)=Πᵢ\hat{N}(ŷᵢ; μᵢ, σᵢ) in train time where μ, σ=hₛ(\hat{z}, Θ) and may have a trainable model implemented by a neural network with a parameter Θ. However, this implementation may be not effective in test time due to the necessity of recalculating a PMF table in a receiver side for each latent point i. Thus, an s number of predefined certain integer resolution PMF tables under zero means different scale parameters (logarithmic distributed scale values between σmin to σmax) may be used. Thus, hyperprior entropy model may implement the following in test time:

$${p}_{h} ( \hat{y} \vert \hat{z} , Θ ) = {{\prod }^{s}}_{c = 1} {\prod }_{i ∈ 𝒩 ( {σ}_{c} )} \hat{N} ( {\tilde{y}}_{i} ; 0 , {σ}_{c} ) \qquad ( 3 )$$

where \tilde{y}ᵢ=Q(yᵢ−μᵢ), ŷᵢ=\tilde{y}ᵢ+μᵢ, σ_{c} may be c-th predefined scale, and N(σ_{c}) may be a set of latent index whose winning scale is σ_{c}.

Examples defining the amortization gap of entropy models and reducing the amortization gap may be provided herein. In examples, a stochastic optimization may find the best φ, θ, Φ, Θ and Ψ parameters to minimize L by amortizing them over the data distribution x˜px. In examples, stochastic optimization may find the best φ, θ, Φ, Θ and Ψ parameters to minimize L by amortizing them over a single input x. According to success of optimization, the parameters may be optimal for entire dataset, but not any specific instance that causes a gap. The cause of amortization gap in compression schema may be any trainable blocks in the model. In examples, the amortization gap may occur if (e.g., even if) the entropy models' (pf, ph) are perfect for given instance. In order to find an instance of a specific optimal entropy model within the same family, maximizing a log-likelihood by any optimization tool may not be needed, since a normalized histogram itself may be the PMF that maximizes the log-likelihood. The following lemmas state actual histogram of the latent may be used:

Definition 1. Amortization Gap of the Entropy Model is the expected gain in bit length, if the entropy models' pmfs are optimal on given instance. The gap can be calculated for the factorized entropy model as follows;

$${𝒢}_{f} = - log ( {p}_{f} ( \hat{z} \vert Ψ ) ) + log ( {p}_{f}^{*} ( \hat{z} ) ) \qquad ( 4 )$$

p*_{f}(\hat{z}) refers to the optimal entropy model within the same entropy family [symbol] , i.e. p*_{f}(\hat{z})=argma [symbol] log (p_{f}(\hat{z})). For hyperprior entropy model, it is;

$${𝒢}_{h} = - log ( {p}_{h} ( \hat{y} \vert \hat{z} , Θ ) ) + log ( {p}_{h}^{*} ( \hat{y} ) ) \qquad ( 5 )$$

p*ₕ(ŷ) refers to the optimal entropy model within the same entropy family [symbol] , i.e. p*ₕ(ŷ)=argm [symbol] log (pₕ(ŷ)).

Lemma 1. Optimal factorized entropy model applies the following closed form equation;

$${p}_{f}^{*} ( \hat{z} ) = {{\prod }^{f}}_{c = 1} {\prod }_{i , j = 1}^{k , k} {h}_{f}^{( c )} ( {\hat{z}}_{i , j , c} ) \qquad ( 6 )$$

where h_{f}^{(c)}(x)=Σ_{i,j}δ(x,\hat{z}_{i,j,c})/k² is normalized frequency of symbol x on k×k slice of \hat{z} and δ (·,·) is kronecker delta.

Lemma 2. Optimal hyperprior entropy model applies the following closed form equation;

$${p}_{h}^{*} ( \hat{y} ) = {{\prod }^{s}}_{c = 1} {\prod }_{i ∈ 𝒩 ( {σ}_{c} )} {h}_{h}^{( c )} ( {\tilde{y}}_{i} ) \qquad ( 7 )$$

where hₕ^{(c)}(x)= [symbol] _{(σ}_{_{c}}₎δ(x, \tilde{y}ᵢ)/| [symbol] (σ_{c})| is normalized frequency symbol x on \tilde{y}ᵢ where i∈ [symbol] (σ_{c}) and | [symbol] (σ_{c})| is the number of element in the given set.

An example encoding algorithm (Algorithm 1) and decoding algorithm (Algorithm 2) are shown below:

```
Algorithm 1 Proposed Factorized Encoding
  Input: Learned pmfs \hat{p}_{Ψ}^{(c)} for c = 1 . . . ƒ, and latents \hat{z} ∈ [symbol]   ^{k×k×f}.
  Output: latent bit-stream lb and parameter bitstream pb.
  Reorder \hat{p}_{Ψ}^{(c)} for c = 1 . . . ƒ w.r.t its entropy
  for c = 1 to ƒ do
    β^{(c)}* = argmax_{β} Σ_{i,j} log (\tilde{p}(\hat{z}_{i,j,c}); β^{(c)})) // find parameters
    \hat{β}^{(c)}* = Q(β^{(c)}*) // quantize the best parameters [symbol]
      = Σ_{i,j} −log(\hat{p}_{Ψ}^{(c)} (\hat{z}_{i,j,c})) + log (\tilde{p}(\hat{z}_{i,j,c}; \hat{β}^{(c)})) // gain
    if [symbol]   > th then
      pb.write(True);pb.write(\hat{β}^{(c)}*) // write parameters explicitly
      lb.write(\hat{z}_{:,c}, \tilde{p}(.; \hat{β}^{(c)}*)) // write latent w.r.t new pmf
    else
      pb.write(False)
      lb.write(\hat{z}_{:,c}, \hat{p}_{Ψ}^{(c)}) // write latent w.r.t learned pmf
    end if
  end for
```

```
Algorithm 2 Proposed Factorized Decoding
  Input: Learned pmfs \hat{p}_{Ψ}^{(c)} for c = 1 . . . s, bitstreams lb and pb.
  Output: Latents \hat{z} ∈ [symbol]   ^{k×k×ƒ}.
  Reorder \hat{p}_{Ψ}^{(c)} for c = 1 . . . ƒ w.r.t its entropy
  for c = 1 to f do
    state = pb.read( )
    if state then
      \hat{β}^{(c)} = pb.read( ) // read parameters
      \hat{z}_{:,c} = lb.read(\tilde{p}(.; \hat{β}^{(c)})) / read latent w.r.t new pmf
    else
      \hat{z}_{:,c} = lb.read(\hat{p}_{Ψ}^{(c)}) // read latent w.r.t learned pmf
    end if
  end for
```

Lemma 1 and 2 may close the amortization gap of the entropy model by replacing learned PMF tables with a histogram of actual latents. In examples, these histograms may be transferred to receiver side that may enlarge the bit-stream more than the expected gain. The PMFs of factorized and hyperprior entropy models may be parameterized by any parametric distribution \tilde{ρ}_{f|h}(·, β) for a given image. In examples, if the expected bit gain is bigger than the necessary number of bits to encode the parameter β explicitly, the encoder may determine to use \tilde{ρ}_{f|h}(·, β) to encode the latents into a bit-stream. In examples, if the expected bit gain is bigger than the necessary number of bits to encode the parameter β explicitly, the encoder may determine to use \tilde{p}_(f|h) (·,β) to encode the latents into a learned PMF (\hat{ρ}_{Ψ}(·) or \hat{N}(·; 0, σ)) and encode a β into bit-stream as extra data. Otherwise, learned PMFs may be used. The decoder read these parameters from video data (e.g., a video file) and create PMFs used by the encoder. Since the binary state shows whether the parametric PMF may be used by sender or not, it may be written into a bitstream for each PMF. The examples may enlarge the file size by a number of targeted PMFs (e.g., naively it may be an s in hyperprior or an f in a factorized entropy, but it may be restricted for top an S number of PMFs in terms of entropy bits).

FIG. 6 illustrates examples of learned PMFs, the updated PMFs (e.g., reparameterization PMFs), and normalized frequencies for an image's selected latent under factorized and hyperprior entropy models respectively. Examples of truncated gaussian mixture on discrete support may be provided. Since the factorized entropy model may be a non-parametric distribution model, the PMF may be flexible enough to have any shape. A Gaussian Mixture Model (GMM) may approximate any smooth density function with a cost of three parameters per component. However, in examples, the function to be approximated may be defined on an integer center and the support domain may be truncated such that [xmin . . . xmax]. Thus, an example mixture model's PMF for factorized entropy model \tilde{ρ}_{f}(x, β^{(c)}) may be:

$${\tilde{p}}_{f} ( x ; {β}^{( c )} ) = \frac{{\sum }_{k = 1}^{K} {π}_{k} N ( x ; {μ}_{k} , {σ}_{k} )}{{\sum }_{z = {x}_{min}}^{{x}_{max}} {\sum }_{k = 1}^{K} {π}_{k} N ( z ; {μ}_{k} , {σ}_{k} )} \qquad ( 8 )$$

Here β^{(c)} [πₖ, μₖ, σₖ]k=1 . . . K may refer the parameters to be tuned in (8) for c-th latent band. Since there may be no closed form solution of β^{(c)}* that maximizes (8), it can be found by using any optimization tools. As shown in the left graph in FIG. 6, there may be a histogram of latents, its learned pmf and parametrization truncated GMM with K=2 given in (8). The learned PMFs and normalized frequencies may be for a certain image's selected latent under factorized and hyperprior entropy models respectively. The reparameterization may fit better on the normalized frequencies, thus compression is better. Hyperprior entropy models' PMFs may be parametric and already modelled by predefined zero mean but different scaled normal PMFs. Thus, the shape of the histogram of the latents may not be as flexible as a factorized model and scale a parameter's mismatch may be the main gap source. A special case of (8) where K=1 and μ=0 may result in no need for π. The scale parameter may be tuned that makes the parameter set β^{(c)}=[σ](8) for hyperprior models in may be rewritten as shown below in (9):

$${\tilde{p}}_{h} ( x ; {β}^{( c )} ) = \frac{N ( x ; 0 , {β}^{( c )} )}{{\sum }_{z = {x}_{min}}^{{x}_{max}} N ( z ; 0 , {β}^{〈 c )} )} \qquad ( 9 )$$

As shown in the right graph in FIG. 6, there may be a histogram of latents, its learned PMF in the baseline model, and reparameterization with truncated zero-mean gaussian in (9).

Examples of the differences of the center bins probability may be provided herein. There may be no closed form solution of β^{(c)}* in (8) and (9). However, since there is just one parameter to be optimized in (9) and (σc) is as a good initial point of optimization, quadratic solver may find the solution with negligible time. In examples, parameterizing the PMF by the error of center bins probability and spreading this error to the other bins proportionally may be a closed form alternative. A reparametrized c-th PMF of hyperprior entropy model (e.g., in this approach) may be written in (10) where the parameter β may be the error of the center bins probability between a learned one and the actual one in the histogram such as β^{(c)}=\hat{N}(0; 0, σ_{c})−h^{(c)}(0).

$${\tilde{p}}_{h} ( x ; {β}^{( c )} ) = \{ \begin{matrix}\hat{N} ( x ; 0 , {σ}_{c} ) - {β}^{( c )} & x = 0 \\ \hat{N} ( x ; 0 , {σ}_{c} ) ( 1 + \frac{{β}^{( c )}}{1 - \hat{N} ( 0 ; 0 , {σ}_{c} )} ) & else\end{matrix} \qquad ( 10 )$$

Table 1 shows the amortization gap of the entropy models relative to the original size for the lowest bqq objective in an example coding device. The numbers in parenthesis may refer to the relative amount of the data encoded by a factorized or hyperprior entropy model. Table 1 is shown below:

TABLE 1
Amortization gap of the entropy models relative to
the original file size for the methods trained lowest bpp objec-
tive in [21]. Numbers in the parenthesis refer relative amount
of the data encoded by certain entropy model.

| | FACTORIZED | HYPERPRIOR | TOTAL |
|---|---|---|---|
| MODEL | ENTROPY GAP | ENTROPY GAP | GAP |
| BMSHJ2018-FACTORIZED [3] | %9.5 (%100) | − | %9.5 |
| BMSHJ2018-HYPERPRIOR [4] | %10.0 (%3.5) | %4.5 (%96.5) | %4.7 |
| MBT2018-MEAN [5] | %11.4 (%5.9) | %3.4 (%94.1) | %3.8 |
| MBT2018 [5] | %9.9 (%2.3) | %2.5 (%97.7) | %2.7 |
| CHENG2020-ANCHOR [7] | %11.8 (%1.2) | %2.3 (%98.8) | %2.5 |
| CHENG2020-ATTN [7] | %9.5 (%2.3) | %1.9 (%97.7) | %2.1 |

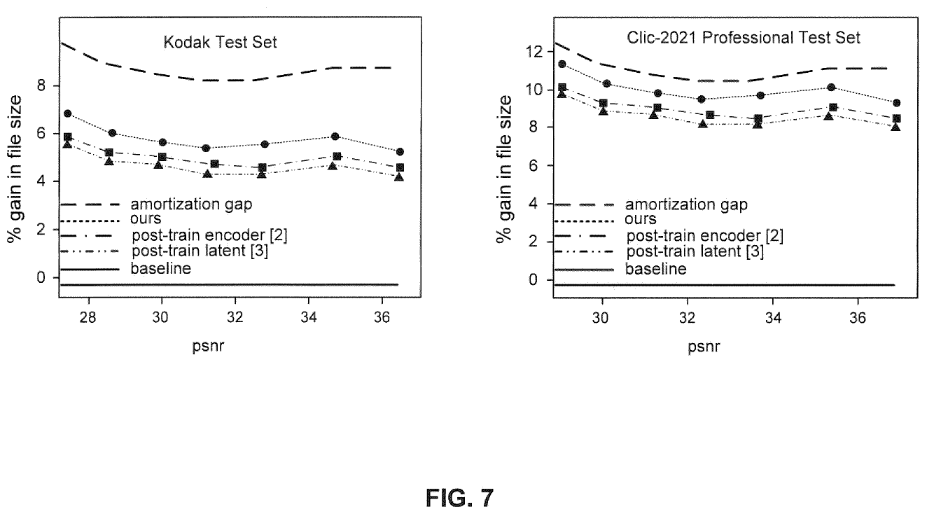

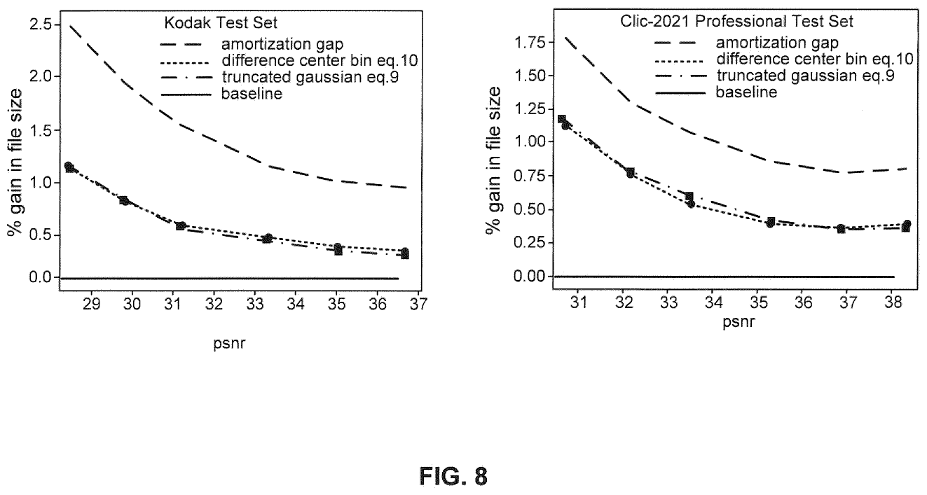

FIG. 7 illustrates experimental results on image test sets for fully factorized entropy model. FIG. 8 illustrates experimental results on image test sets for hyperprior entropy model. An example video coding device neural image compression library 1 may be used in order to test baselines and our contributions. The amortization gap of pre-trained features in the example video coding device library on Kodak test set 2 may be measured. The results are given in Table 1. Regardless of the baseline features, the factorized entropy model's amortization gap may be quite large (%9.5-%11.8) compared to the hyperpriors one (%1.9-%4.5). FIG. 6 shows that mismatch between hf and p\hat{ }^{Ψ} may be much bigger than hh and N\hat{ }. This may be because the hyperprior entropy model may use instance specific information, and the fully factorized model may not. The hyperprior model may encode a very small amount of the data (%1.2-%5.9) with the less effective entropy model (factorized entropy), but vast majority of the data (%94.1-%98.8) may be encoded by effective entropy model (hyperprior entropy). In average, the amortization gap (%2.1-%4.7) may be smaller compared to the fully factorized method (%9.5). From the different version of same example, if the amount of side information decreases, correspondingly the hyperprior gap may increase. For example, the hyperprior gap may be %3.4 where there is %5.9 side information (to predict mean and scale values) but may be %4.5 where there is %3.5 side information (e.g., to predict just scale values).

In order to measure the performance of examples (e.g., in addition to 24 images in Kodak dataset), 60 images in Clic-2021 Challenge's Professional test set 3 may be used. The amortization gap may be measured and the explicit parametrization may by truncated GMM, which may reduce this gap for fully factorized entropy model (e.g., no side information, main information encoded by factorized entropy) as shown in FIG. 7. k=2 may be used and 5 parameters may be written (e.g., 2 mean, 2 scale and 1 relative weight quantized into 1024 bins) into a file explicitly using a 10-bit per parameter as extra data. The PMF table may be replaced if the gain in examples is above 50-bits for this certain PMF. The example may be plugged in an already trained model for 7 different psnr targets. As shown in FIG. 7, the amortization gap may vary from %8.5 to %9.5 in Kodak dataset, where the example gains may be from %5.3 to %6.8 in file size. In Click-2021 dataset, the gap (%9.5-%12.5) and gain (%8-%11.5) may be even bigger, where the gap may be almost closed. At least the following two instance based post-training examples may be provided: post-train encoder (e.g., trains the encoder for given test image); or post-train latent (e.g., learns more effective instance's latent directly without training the encoder). A reference work may be faster (e.g., but still may need significant time to train) than another work but may have less performance as shown in FIG. 7. Examples herein may reach better results and significantly outperform compared to the two post-training approaches (e.g., even without giving any significant computational complexity).

Examples of a hyperprior model are provided herein. To test the two examples given in Equations (9) and (10), the neural compressing model cheng2020-anchor may be provided. Models may be trained for 6 different objectives on RD curve. Since both examples may explicitly encode a single parameter per replaced PMF table and these parameters may be quantized in 1024 bins. 10 bits may be used as a threshold value to make decisions on whether the PMF should be replaced or not. The results are shown in FIG. 8, and both approaches may save more than %1 of an original file size in lower bitrate and may save around %0.5 in a highest bitrate. Examples that parametrize the (e.g., new) probability by the difference between center bin's probability in (10) may give a competitive result even better in a higher psnr objective with zero-mean truncated gaussian distribution.

The defined model may recalculate PMF tables on the decoder side. Due to the different architecture and/or software that may exist in encoder and decoder side, the PMF table may be slightly different to each other because of floating point round-off error which may result in disastrous reconstruction. This limitation may be solved by hard coding possible (e.g., all possible) PMF tables (under the discretization level of explicit parameter) in encoder and decoder in advance. Thus, explicit parameters as described herein may play selector role out of these predefined PMF tables. But the parameters may enlarge the decoder size which may (e.g., may also) be important in some cases. This may not be an issue in the hyperprior entropy model by differences of center bins. Because the values in PMF and actual histograms may be integers, their difference may be an integer. This integer value may be spread across histogram bins (e.g., all histogram bins) proportionally but not to the center bin. Different architectures may (e.g., may need to) divide two integers and round the result down which may be identical in platforms (e.g., all platforms).

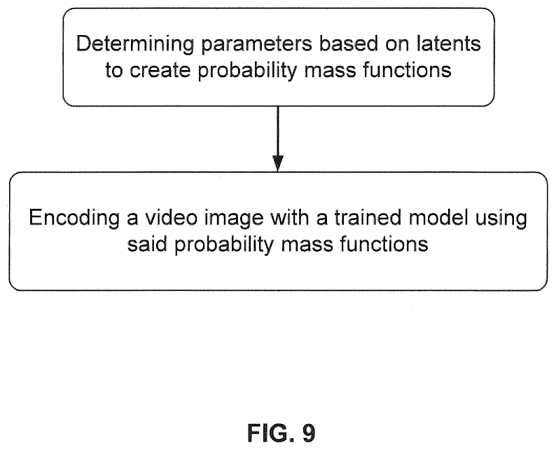

FIG. 9 illustrates an example for encoding video data. The example begins at a start block and proceeds to a block for determining parameters based on latents to create probability mass functions. The example proceeds to a block for encoding the determined parameters explicitly under predetermined discretization and a video image with a trained model using the probability mass functions.

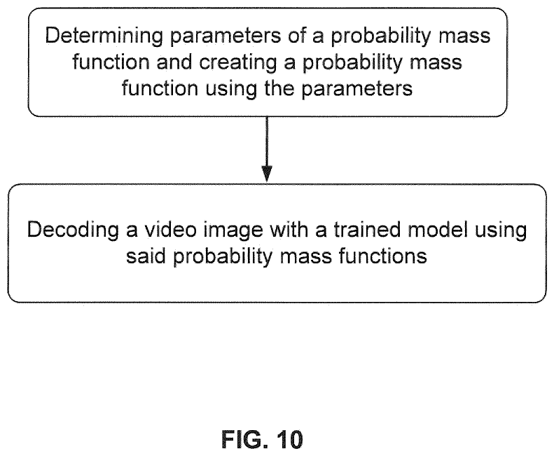

FIG. 10 illustrates an example for decoding video data. The example begins at a start block and proceeds to a block for determining parameters of a probability mass function and creating a probability mass function using the parameters. The example proceeds to a block for decoding a video image with a trained model using the probability mass function.

End-to-end trainable models on single image compression have been successful. These models may outperform traditional image codecs that may be created long incremental works. In video compression, neural codecs may be inefficient on reducing the temporal redundancy. In video compression, the latent's density estimation may be inefficient in the learned model(s) (e.g., neural model(s)). The latter may be defined by a mismatch between test latent's histogram and the learned symbol probabilities. This mismatch, which may be known as an amortization gap of entropy model, may enlarge the file size of compressed data. The cost of this mismatch may be calculated in terms of relative file size for video compression examples. Reparameterization based examples may be effective to reduce this gap. Reparameterization based examples may save around 5% of the file size without having any effect on reconstruction quality. Reparameterization based examples may be applied to any neural video codec's entropy model directly.

Image and video compression may be a fundamental task in image processing, which has become important in the time of pandemic and increasing video streaming. Some examples (e.g., including linear transformations under heavy optimized handcrafted techniques) may have reached current state of the art rate-distortion (RD) performance. End-to-end trainable deep models may achieve high peak signal-to-noise ratio (PSNR) for single image compression. In examples, the mismatch between test latent's normalized histograms and learned distributions in the entropy models may be a cause of the inefficiency of learned models on temporal redundancy. Examples may be provided herein to improve the RD performance of end-to-end trainable model at a minor cost of computation.

Lossy image compression via end-to-end trainable models may be a special kind of Variational Autoencoder (VAE) that may learn the transformations between data and latent codes and the probability models of these latent codes jointly. A multi-objective optimization problem may be provided where the model may be optimized for reconstruction quality and cross entropy of latent code with respect to learned probabilities known as RD loss function. These neural image codecs may be extended by using (e.g., two) VAEs, one for encoding motion information, another for encoding residual information in end-to-end video compression. Trainable models may suffer from an amortization gap (e.g., which may be optimal for entire dataset, but sub-optimal for a given test instance). This gap may reduce the performance by either enlarging the file size and degrading reconstruction quality. Post training may be applied for given single test image/video. For example, the encoder part of VAE may be trained in order to prevent extra signaling cost. For example, parts of the model may be finetuned by adding signaling cost to the loss function. Post training may adjust some parameters of the model. In examples, the entropy model's amortization gap in end to-end image compression may be targeted and an instance specific reparameterization of the latent distribution may be provided.

Learned models (e.g., end-to-end trainable models) may be used on video compression. The amortization gap of the entropy models for different frames (e.g., I, B and P frames) for different information (e.g., motion and residual) in neural video compression examples may show where the performance drop is and how it can be fixed. The efficiency of probability reparameterization examples may be provided where the updated (e.g., new) parameters are kept into file considering the temporal redundancy of these parameters. The file size of video may be decreased around 5% in average. In examples herein, the amortization gap of neural video compression may be closed without post-training.

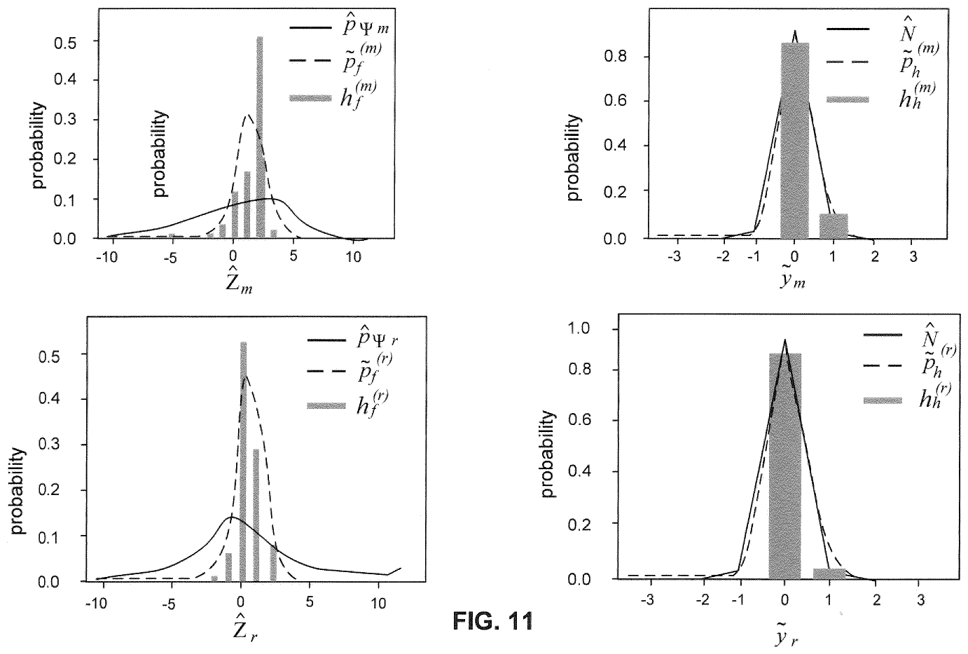

FIG. 11 illustrates examples of learned PMF tables in a model, PMF after reparameterization in a model, and normalized frequencies. In examples, end-to-end image compression model may (e.g., may only) use a factorized entropy model, which may have followed examples with hierarchical VAE based hyperprior entropy models in neural image compression and neural video compression. x, x̅, \hat{x}, \hat{x}ᵣ may represent the current image, motion warped current image, the reconstruction of current image, and the reconstruction of reference image. v may indicate the predicted motion information, yₘ, ŷₘ, yᵣ, ŷᵣ continuous latent, quantized (or noise added) latent of motion information, and residual information respectively. zₘ, \hat{z}ₘ, zᵣ, \hat{z}ᵣ may include a continuous side latent, a quantized (or noise added) side latent of motion information, and a residual information respectively. A Q(·) element-wise function may apply a quantization in test time or its continuous relaxation in train time as Q(x)=x+ϵ that ϵ˜U(−0.5,0.5) and W(·,·) warps a given image with respect to a given motion. A first VAE whose aim may be to encode motion information, may take a current frame and a reconstructed reference frame (or in B frame encoding, 2 reference frames) as inputs and finds warped image by yₘ=gmₐ(x, \hat{x}ᵣ; φₘ), ŷₘ=Q(yₘ), σ=gmₛ(ŷₘ; θₘ), zₘ=hmₐ(yₘ; Φₘ), \hat{z}ₘ=Q(zₘ), and x̅=W(\hat{x}ᵣ, σ). A second VAE may be used for encoding residual information (difference between current frame and its motion warped version) and reconstructing the image by applying yᵣ=grₐ(x−\hat{x}; φᵣ)ŷᵣ=Q(yᵣ), zᵣ=hrₐ(yᵣ; Φᵣ), \hat{z}ᵣ=Q (zᵣ), and \hat{x}=grₛ(ŷᵣ; θᵣ)+x̅. If gmₐ, gmₛ, hmₐ, grₐ, grₛ, hrₐ are trainable deep models, neural video compression loss may be written as follows:

$$ℒ = {𝔼}_{{X , {\hat{X}}_{r} \sim {p}_{x}}_{ϵ \sim U}} [ - log ( {p}_{h}^{( m )} ( {\hat{y}}_{m} \vert {\hat{z}}_{m} , {Θ}_{m} ) ) - log ( {p}_{f}^{( m )} ( {\hat{z}}_{m} \vert {Ψ}_{m} ) ) - log ( {p}_{h}^{( r )} ( {\hat{y}}_{r} \vert {\hat{z}}_{r} , {Θ}_{r} ) ) - log ( {p}_{f}^{( r )} ( {\hat{z}}_{r} \vert {Ψ}_{r} ) ) + λ \cdot d ( x , \hat{x} ) ] \qquad ( 11 )$$

where ρ_{f}^{(m)}(·|Ψₘ) and ρ_{f}^{(r)}(·|Ψᵣ) may be factorized entropy models for motion and residual information, ρₕ^{(m)}(·|\hat{z}, Θₘ) and ρₕ^{(r)}(·|\hat{z}, Θᵣ) may be hyperprior entropy models for motion and residual information, respectively implemented with neural networks, d(·,·) may be any distortion loss such as MSE for PSNR metric, and λ may be a hyperparameter that plays trade-off role between compression ratio and quality. Here, the variables to be written into compressed file may be a motion's main and side information (ŷₘ, \hat{z}ₘ) and a residual's main and side information ŷᵣ, \hat{z}ᵣ), whose expected file sizes under learned entropy models may form the first four part of the loss in (11).

Factorized entropy models learn the PMF of the symbols for each feature band of \hat{z}ₘ and \hat{z}ᵣ separately. Thus, learned PMF values may be defined by weights of factorized entropy model Ψm,Ψr. If the side latent of motion or residual information is \hat{z}_{m|r}∈R^{k×k×f} and \hat{ρ}_{Ψ}_{_{m|r}}^{(c)}(·) is the pmf table of c-th feature band for motion or residual information, a factorized entropy model may be applied as follows:

$${p}_{f}^{( m \vert r )} ( {\hat{z}}_{m \vert r} \vert {Ψ}_{m \vert r} ) = {{\prod }^{f}}_{c = 1} {\prod }_{i , j = 1}^{k , k} {\hat{p}}_{{Ψ}_{m \vert r}}^{( c )} ( {\hat{z}}_{m \vert r , i , j , c} ) \qquad ( 12 )$$

A hyperprior entropy model may learn the parameters of a main information's probability function (e.g., usually a gaussian or a laplacian distribution is used) using an already encoded side latent by μ, σ=hmₛ(\hat{z}ₘ, Θₘ) or μ, σ=hrₛ(\hat{z}ᵣ, Θᵣ) for motion or residual information and may apply it as follows:

$${p}_{h}^{( m \vert r )} ( {\hat{y}}_{m \vert r} \vert {\hat{z}}_{m \vert r} , {Θ}_{m \vert r} ) = {{\prod }^{s}}_{c = 1} {\prod }_{i ∈ 𝒩 ( {σ}_{c} )} N ( {\tilde{y}}_{m \vert r , i} ; 0 , {σ}_{c} ) \qquad ( 13 )$$

where \tilde{y}_{m|r,i}=Q(y_{m|r,i}−μᵢ), ŷ_{m|r,i}=\tilde{y}_{m|r,i}+μᵢ, σc may be c-th predefined scale, N(σc) may be a set of latent index whose winning scale may be a σc, \hat{N}(x; μ, σ) PMF value of x for 1-d gaussian distribution with μ, σ parameters, s may be a number of predefined scale values of gaussian distribution and hms,hrs may be deep neural networks.

For example, end-to-end video compression may include five trainable components for motion information, five components for residual information parameterized by φm,θm,ϕm,Θm,Ψm and φr,θr,ϕr,Θr,Ψr respectively, and a non-trainable motion warping function W(·,·). The selection of these 11 components may explain the differences between end-to-end video compression examples.

The gap caused by the mismatch between marginal and learned distribution may be reduced. If considering intra frame encoding (I frame, as single image encoding), there may be no motion and reference images, thus the first two components of the loss in (11) may be canceled out and x̅=0. It may lead to a residual's main and side information to be encoded into video data (e.g., file bitstream) for l frame encoding. In inter frame encoding (either B or P), both a motion's and residual's main and side information may be encoded into a file. Using entropy models in (12) and (13), expected bitlength of c-th feature band of side information may be written as follows:

$${l}_{f , c}^{( m \vert r )} = - {\sum }_{i , j = 1}^{k , k} log ( {\hat{p}}_{{Ψ}_{m \vert r}}^{( c )} ( {\hat{z}}_{m \vert r , i , j , c} ) ) \qquad ( 14 )$$

The expected bitlength of main information that is represented by c-th predefined scale may be written as follows:

$${l}_{h , c}^{( m \vert r )} = - {\sum }_{i ∈ 𝒩 ( {σ}_{c} )} log ( \hat{N} ( {\tilde{y}}_{m \vert r , i} ; 0 , {σ}_{c} ) ) \qquad ( 15 )$$

Considering side information's bitlength, it may be calculated by l_{f}^{(m|r)}=Σ_{c}(l_{f,c}^{(m|r)}) and for a main information's bitlength. The baseline example's expected bitlength of an inter frame may be provided by summing up the 4 information's bitlength by l_{base}−l_{fm}+lₕₘ+l_{fr}+lₕᵣ.

The optimality of bit length of each information may depend on how close learned PMFs (ρ_{Ψ}_{ₘ}, ρ_{Ψ}_{ᵣ}, \hat{N}(\tilde{y}ₘ; 0, σc_{),} \hat{N}(\tilde{y}ᵣ; 0, σ_{c}) are to a marginal distribution of latents (\hat{z}ₘ, \hat{z}ᵣ, ŷₘ, ŷᵣ) and it may be defined as amortization gap of entropy models in neural image compression. This mismatch may be seen by differences between green curves and blue histogram bars in FIG. 11. The theoretical limit of expected bit length of information may be calculated (e.g., following the same procedure) by simply replacing the learned PMF by a corresponding latent's normalized histogram as follows:

$${l}_{f , c}^{* ( m \vert r )} = - {\sum }_{i , j = 1}^{k , k} log ( {h}_{f , c}^{( m \vert r )} ( {\hat{z}}_{m \vert r , i , j , c} ) ) \qquad ( 16 )$$

where h_{f,c}^{(m|r)}(x)=Σ_{i,j}^{δ(x, \hat{z}}^{_{m|r,i,j,c)}}^{/k}^{²} may represent normalized frequency of symbol x on k×k slice of \hat{z}_{m|r} and δ(·,·) may represent kronecker delta. Theoretical limit of expected bit length of main information may be written as follows:

$${l}_{h , c}^{* ( m \vert r )} = - {\sum }_{i ∈ 𝒩 ( {σ}_{c} )} log ( {h}_{h , c}^{( m \vert r )} ( {\tilde{y}}_{m \vert r , i} ) ) \qquad ( 17 )$$

where h_{h,c}^{(m|r)}(x)= [symbol] δ(x,y̅_{m|r,i})/| [symbol] (σ_{c})| may be a normalized frequency of symbol x on \tilde{y}_{m|r,i}, where i ∈N(σc) and |N(σc)| may be the number of element in the given set. Following the same procedure, a bit length of all side and main information may be calculated by l*_{f}^{(m|r)}=Σ_{c}(l*_{f,c}^{(m|r)}) and l*ₕ^{(m|r)}=Σ_{c}(l*_{h,c}^{(m|r)}). Thus, a theoretical limit of expected bit length of an inter frame may be l*=l*_{f}^{m}+l*ₕ^{m}+l*_{f}^{r}+l*ₕ^{r}. The differences between the baseline model's information bit length and the theoretical limits of the bit length may give the amortization gap of the corresponding type of information.

Temporal reparameterization may be performed. In order to reduce the mismatch, one or more learned model(s) (e.g., PMFs in the model) may be replaced by updated model(s). For example, the updated models may include some parametric distribution \tilde{ρ}_{f|h}^{(m|r)} whose parameters β may be optimized for fitting actual histogram of the latents as much as possible. One or more parameters of the selected distribution may be discretized into 10 bits, thus the parameter may enlarge the bit length 10 bits. The same reparameterizations that truncated gaussian mixture may be used for h_{f}^{(m)} and h_{f}^{(r)} and truncated zero-mean gaussian distribution may be for hyperprior entropy (e.g., information of motion and residual, hₕ^{(m)} and hₕ^{(r)}) with some key differences. Updated (e.g., new) PMF tables with K=1 gaussian mixture and zero-mean gaussian may be found in FIG. 11 in the dashed curves for different types (e.g., all different types) of information. K=1 may be used as an example but any arbitrary number of gaussian may be used.

In examples, extra parameters for one or more frames may be encoded explicitly. In examples, an S-bit temporal mask may be used to explain if the previously encoded interframe's corresponding parameter is the same or not for the top S number of PMF tables. If this bit is 1, there may be no need to encode updated (e.g., new) parameters. The previously encoded interframe's parameters may be used. In these examples, the temporal redundancy of these parameters may be decreased. If considering the signaling cost of PMF tables (e.g., each PMF table), just a few of the PMF tables (e.g., the learned PMF tables) may be worth replacing with a reparameterization PMF table. To determine which PMF tables worth replacing, a top S number of PMF tables may be tested to determine if the expected bit gain is larger than reparameterization cost or not. The updated (e.g., new) parameters may be written to the file and PMF may be replaced if the gain is larger than that signaling cost. If K number of mixture is used, the signaling cost may be 10(3K−1) bits in factorized entropy. Since there is just one parameter in zero-mean gaussian, the signaling cost may be 10 bits in a hyperprior model if the temporal mask is 0. If the parameters are the same with previously encoded interframe, a signaling cost may be 0 bit for entropy models (e.g., all entropy models). To tell the decoder (e.g., receiver) which PMF is replaced, a 1-bit replacement mask may be used in addition to replaced PMF's parameters and a temporal mask. As long as \tilde{ρ}(·; \hat{β}^{(c)}) is the new c-th PMF table parameterized by β\hat{ }(c) and a previous encoded interframe's parameter is \hat{β}*ₚ^{(c)} (e.g., parameters of the first interframe and the PMF table which are not replaced are none), detailed flows are given in Algorithms 3 and 4 for a factorized entropy model. Extending it on a hyperprior entropy model may be a matter of variable names and indexing.

Examples of reducing mismatches between marginal and learned distributions in neural video compression are provided herein.

In neural video codecs, there may be four different types of information to be encoded and/or decoded which may be independent to each other. An extra bitstream for each type of information may be used. In examples, 8 bitstreams may be used where the total length of these 8 bitstreams may be shorter than an original baseline's total length of 4 bitstreams.

Examples of video data (e.g., bitstreams) in the baseline example may include at least one of: a side motion, a main model, a side residual, or a main residual. The side motion may use a factorized entropy model to encode/decode motion's side information. The main motion may use a hyperprior entropy model (e.g., which may use decoded motion's side information) to encode and/or decode a motion's main information. The side residual may use a factorized entropy model to encode and/or decode a residual's side information. The main residual may use a hyperprior entropy model (e.g., which uses decoded residual's side information) to encode and/or decode a residual's main information.

Examples of additional bitstreams may include at least one of: parameters of side motion; parameters of main motion; parameters of side residual; or parameters of main residual. The parameters of side motion may indicate the necessary information to create the adopted PMFs in the motion's factorized entropy model. The parameters of main motion may include the necessary information to create the adopted PMFs in the motion's hyperprior entropy model. The parameters of side residual may include the necessary information to create the adopted PMFs in the residual's factorized entropy model. The parameters of main residual may include the necessary information to create the adopted PMFs in the residual's hyperprior entropy model.

An example video encoding device may determine an entropy model for encoding a picture (e.g., current picture). For example, the video encoding device may select between a prior entropy model and an updated entropy model based on rate distortion optimization. The prior entropy model may be or may include a learned entropy model. The prior entropy model may be or may include an entropy model used for encoding a previous picture (e.g., the picture preceding the current picture). For example, the video encoding device may select between a learned entropy model and an updated entropy model based on rate distortion optimization. The video encoding device may include an indication of the determined entropy model in video data. An example video decoding device may obtain the entropy model indication in video data and determine the entropy model to use for decoding the current picture based on the entropy model indication.

The entropy model indication in video data (e.g., bitstreams) may be configured to indicate whether to use a learned entropy model or an updated entropy model for a picture. The entropy model indication in video data (e.g., bitstreams) may be configured to indicate whether to use a prior entropy model or an updated entropy model for a picture. For example, the entropy model indication may include one or more of the following three different indications (e.g., bits): temporal indications (e.g., temporal bits,) replacement indications (e.g., replacement bits); or parameter indications (e.g., parameter bits).

The temporal indications may be or may include 1-bit information that shows if the corresponding entropy model uses the corresponding parameters of the previously encoded picture (e.g., frame) or not. The temporal indications may be inside the bitstream by S times. The replacement indications may be 1-bit information that shows if the corresponding learned entropy model is replaced by an updated entropy table or not. These bits may be inside the bitstream by number of temporal bits that are zero. The parameter indications may show the explicit bitstream of necessary parameters to create the updated entropy model. If 10-bit discretization of parameters are used, each may have 10 times number of parameters to be encoded (e.g., it may be 3K−1 for factorized entropy model where K is a number of mixtures, 1 for hyperprior entropy model) bits length. Parameter indications may be repeated with the number of replacement indications that are one.

In examples, a PMF table may be associated with or, may be a part of, or may be within an entropy model. In examples, a prior PMF table may be associated with a prior entropy model. In examples, a learned PMF table may be associated with a learned entropy model. In examples, an updated PMF table may be associated with an updated entropy model.

In examples, if the predefined S=32 that shows the targeted PMF table associated with (e.g., in the) entropy model. 32 bits temporal indications may be used. If 20 of the temporal indications are zero, 20 replacement indications may be used. If K=1, each parameter bitstream may have a 20 bit length and if the number of replacement indications that are 1 is 10, the total parameter indications may be 20×10=200 bits. As a result, the additional bitstream may be a 32+20+200=252 bits length.

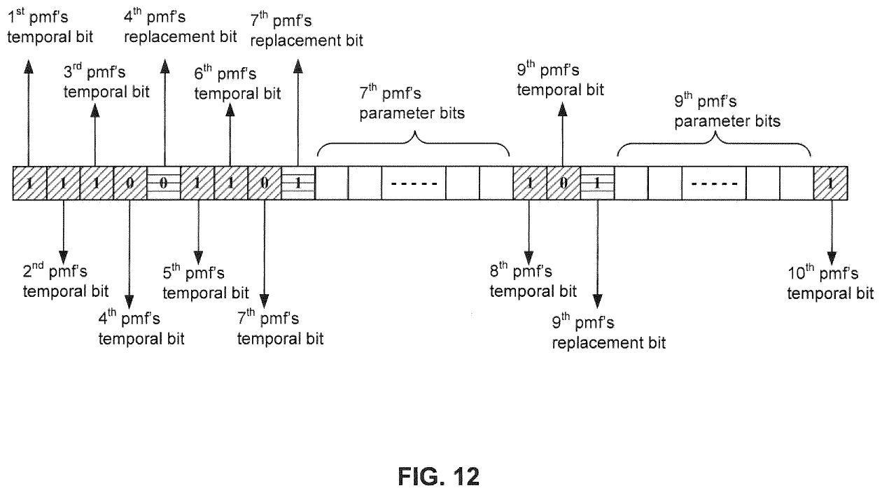

FIG. 12 example entropy model indications that may indicate whether to use a prior entropy model (e.g., PMF table) or an updated entropy model (e.g., PMF table). The example bitstreams may start with back-to-back temporal indications. The temporal indications may continue until and stop after the first zero bit. Every zero temporal indication may be followed by a replacement indication. If the replacement indication is zero, the replacement indication may be followed by the next temporal indication of the entropy model. If the replacement indication is 1, the replacement indication may be followed by parameter indications whose length may depend on a used number of parameters. If there are two parameters to be encoded and the discretization level is 10 bits, the next 20 bits may be parameter indications. Parameter indications may be followed by the next temporal indication of the entropy model.

As shown in FIG. 12, supposed S=10 number of the PMF tables associated with an entropy model (e.g., within the entropy model). An encoder may determine the first 3 entropy models for encoding a current picture. The encoder may select between a prior entropy model and an updated entropy model for the first 3 entropy models. To select between the prior entropy model and the updated entropy model, the encoder may obtain a latent representation of the current picture. The updated entropy model may be derived based on the latent representation. In examples, the encoder may quantize the updated entropy model parameters based on the derivation of the updated entropy model. A gain associated with using the updated entropy and a cost associated with indicating the updated entropy model may be calculated. The encoder may then select between the updated entropy model and the prior entropy model based on the calculation.

In the example shown by FIG. 12, the encoder may select the prior entropy model for the first 3 entropy models (e.g., the entropy model uses the exact same parameters as the parameters of the previously encoded picture). Based on the encoder selecting the prior entropy model, the encoder may set the first 3 temporal indications to indicate that the entropy models are prior entropy models that use the parameters of the previously encoded picture (e.g., the first 3 temporal indications may be set to 1) (e.g., as shown in FIG. 12).

In the example shown by FIG. 12, the encoder may select the updated entropy model for the 4th entropy model (e.g., the entropy model does not use the parameters of the previous picture). Based on the encoder selecting the updated entropy model, the 4th entropy model temporal indication may indicate that the entropy model is not a prior entropy model (e.g., the 4th temporal indication may be set to 0). Based on the 4th temporal indication indicating that the entropy model is not a prior entropy model, the 4th temporal indication may be followed by a 4th replacement indication of the entropy model. The encoder may select between the derived updated entropy model (e.g., based on the latent representation) and a learned entropy model (e.g., an original entropy model) based on the gain associated with using the updated entropy model and the cost associated with indicating the updated entropy model in the video data. In examples, if the parameterization cannot gain enough bits (e.g., any bits) (e.g., the gain compared to the signaling cost is not sufficient), the encoder may decide not to replace the 4th entropy model with the learned entropy model. If the parameterization can gain enough bits (e.g., any bits) (e.g., the gain compared to the signaling cost is not sufficient), the encoder may decide to replace the 4th entropy model with the learned entropy model. As shown in FIG. 12, the encoder may signal the 4th replacement indication to indicate that the 4th entropy model is not replaced (e.g., the 4th entropy model replacement indication may be 0) (e.g., a learned entropy model may be used).

In the example shown in FIG. 12, the encoder may select using prior entropy models as the 5th and 6th entropy models (e.g., they may use a previously encoded parameter of a previous picture). The encoder may signal the 5th and 6th temporal indications to indicate that the 5th and 6th are prior entropy models that use the parameters of the previously encoded picture (e.g., adding two 1 indications). In the example shown in FIG. 12, the encoder may select the updated entropy model as the 7th entropy model (e.g., it may not use a previous frame parameter). The encoder may signal the 7th entropy model temporal indication to indicate the entropy model is not a prior entropy model that uses the parameters of the previously encoded picture (e.g., the 7th entropy model indication may be set to 0). Based on the 7th temporal indication indicating an entropy is not a prior entropy model, the 7th temporal indication may be followed by the 7th entropy table replacement indication. The encoder may select the updated entropy model as the 7th entropy model based on the calculated gain associated with using the updated entropy model compared to the cost associated with indicating the updated entropy model in the video data. The replacement indication may be set to indicate that the 7th entropy model is an updated entropy model. The encoder may include an indication of at least one updated entropy model parameter (e.g., the bitstream may be followed by explicit 10 bit representation of each updated entropy model parameter included in video data).

In examples, if there are 2 parameters per reparameterization of the PMF, it may result in 20 bits length of 7th entropy model parameter indications. As shown in FIG. 12, following the parameter indications, the encoder may signal an 8th entropy model temporal indication, which may indicate the 8th entropy model is a prior entropy model that uses the parameters of the previous picture, (e.g., the 8th temporal indication may be set to 1). As shown in FIG. 12, the encoder may signal the 9th entropy model is not a prior entropy model (e.g., the 9th temporal indication may set to 0). If the encoder selects an updated entropy model, the encoder may include the updated entropy model parameters as parameters indications in the video data (e.g., signal 1 for the replacement indication followed by 20 length of parameter indications). As shown in FIG. 12, the example bitstream may be ended by temporal indication of the last entropy model indicating that the entropy model is a prior entropy model (e.g., the 10th temporal indication may set to 1). As a result, in the example shown in FIG. 12, since S=10, there are 10 temporal bits, since there are 3 temporal bits equal to 0, and out of the 3 replacement bits, since 2 of the replacement bits are 1, there are 2 parameter bitstream that use 2×20=40 bits. The total length of the sample additional bitstream is 53.

An encoder may need the parameters of the previously encoded picture in advance. If it is the first picture to be encoded, the learned entropy model may be used. If the entropy model is not replaced in a previously encoded picture, the learned entropy may be used as well. In a factorized entropy model, the entropy model may need to be reordered with table with respect to their own entropy. In this way, the entropy model may carry more information at the beginning. Replacing the first top S number of entropy models may prevent spending temporal and replacement indications for a vain. In hyperprior model, entropy models may already be ordered with respect to their scales and the highly lower scale entropy models may carry more information than others (e.g., in a hyperprior model, reordering may be not needed).

In examples, entropy model parameters for pictures (e.g., each picture) may be encoded explicitly. In examples, a S-bit temporal mask may be used to explain if the parameters of the previously encoded picture are the same or not for the top S number of entropy models. The encoder may select between the prior entropy model and an updated entropy model for the current picture. The updated entropy model may be derived based on a latent representation (e.g., a number of latents) and the updated entropy model parameters may be quantized based on the derivation. A gain associated with using the updated entropy model parameters may be compared with the cost associated with indication the updated entropy model parameters, which may be used to select between the prior entropy model and the updated entropy model. Based on selecting the prior entropy model for encoding the current picture (e.g., the temporal indication is set to 1), there is no need to encode updated entropy model parameters but to use the prior entropy model parameters associated with a previous picture within the prior entropy model. This may decrease the temporal redundancy of these parameters.

Based on selecting the updated entropy model for encoding the current picture, (e.g., if considering the gain and signaling cost associated with each entropy model), one or more entropy models may be worth replacing with an updated entropy table (e.g., the temporal indication is set to 0) (e.g., but the vast majority of entropy models may not be worth replacing). Based on selecting the updated entropy between the updated entropy model and the prior entropy model (e.g., setting the temporal indication to 0), to determine which entropy models are worth replacing, the top S number of entropy models may be tested one by one to determine if the expected bit gain is larger than the reparameterization (e.g., signaling) cost or not. The encoder may select between the updated entropy model and the learned entropy model based on the gain associated with using the entropy model compared with the cost associated with indicating the updated entropy model in video data. The updated entropy model parameters may be written into the video data and the learned entropy model may be replaced if the gain is larger than that signaling cost. In examples, if K number of mixture is used, the signaling cost may be 10(3K−1) bits in factorized entropy. Since there may be just one parameter in zero-mean gaussian, the signaling cost may be 10 bits in hyperprior model if the temporal indication (e.g., mask) is 0. If the parameters are the same with previously encoded picture, the signaling cost may be 0 bits for the entropy models.

Based on the encoder selecting to replace the learned entropy model with the updated model, a 1-bit replacement indication may be used in addition to including the updated entropy model parameters (e.g., and a temporal indication) in the video data. Based on selecting the learned entropy model for encoding the current picture, the 0-bit replacement indication may be used to indicate the updated entropy model is not replacing the learned entropy model. An example encoding schema for factorized entropy model's baseline bitstream (e.g., side motion or side residual, lb in the algorithm) and additional bitstream (e.g., parameter of side motion or parameter of side residual, pb in the algorithm) is given below in Algorithm 3:

```
Algorithm 3 Encoding with Factorized Entropy
  Input: Learned pmfs for \hat{p}_{Ψ}^{(c)} c = 1 . . . s, latents \hat{z} ∈ [symbol]   ^{k×k×s}, number
  of mixture K and previous interframe's params \hat{β}ₚ*^{(c)} for c = 1 . . . s.
  Output: latent bit-stream lb and parameter bitstream pb.
  Reorder \hat{p}_{Ψ}^{(c)} for c = 1 . . . s w.r.t its entropy
  for c = 1 to S do
    β*^{(c)} = argmax_{β} Σ_{i,j} log (\hat{p}(\hat{z}_{i,j,c}); β^{(c)})) // find parameters
    \hat{β}^{(c)} = Q(β*^{(c)}) // quantize the best parameters [symbol]
      = Σ_{i,j} −log(\hat{p}_{Ψ}^{(c)} (\hat{z}_{i,j,c})) + log(\tilde{p}(\hat{z}_{i,j,c}; \hat{β}*^{(c)})) // gain
    if \hat{β}ₚ*^{(c)} = None and [symbol]   <= 30K − 10 then
      pb.write(True) // write temporal mask
      \hat{β}*^{(c)} = None // set best params None
      lb.write(\hat{z}:,_{c}, \hat{p}_{Ψ}^{(c)} ) // write latent w.r.t learned pmf
    else if \hat{β}*^{(c)} = \hat{β}ₚ*^{(c)} and [symbol]   > 0 then
      pb.write(True) // write temporal mask
      lb.write(\hat{z}_{:,c},\hat{p}(.;\hat{β}ₚ*^{(c)})) // write latent w.r.t previous pmf
    else if [symbol]   30K − 10 then
      pb.write(False) // write temporal mask
      pb.write(True) // write replacement mask
      pb.write(\hat{β}*^{(c)}) // write parameters explicitly
      lb.write(\hat{z}:_{,c},\hat{p}(.;\hat{β}*^{(c)})) // write latent w.r.t new pmf
    else
      pb.write(False) // write temporal mask
      pb.write(False) // write replacement mask
      \hat{β}*^{(c)} = None // set best params None
      lb.write(\hat{z}:_{,c},\hat{p}_{Ψ}^{(c)}) // write latent w.r.t learned pmf
    end if
  end for
  for c = S + 1 to s do
    lb.write(\hat{z}_{:,c}, \hat{p}_{Ψ}^{(c)}) // write latent w.r.t learned pmf
  end for
```

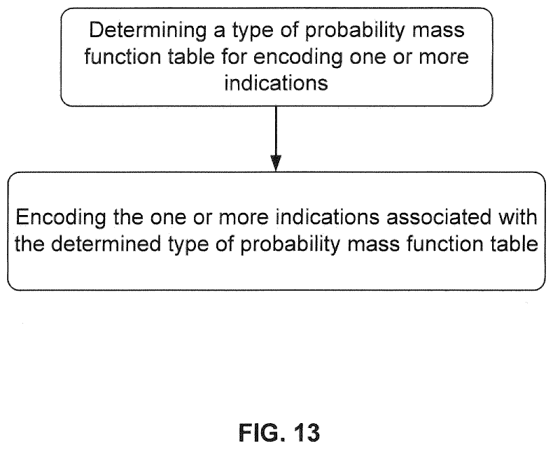

FIG. 13 illustrates an example for encoding with factorized entropy (e.g., which may apply to Algorithm 3 above). FIG. 13 shows an example of determining a type of entropy model that may be associated with the current picture for encoding one or more entropy model indications. The one or more indications associated with the current picture may be encoded using the determined type of entropy model. In examples, the prior entropy model may be or may include a learned entropy model. In examples, the prior entropy model may be or may include an entropy model used for encoding a previous picture (e.g., the picture preceding the current picture). In examples, the entropy model indication(s) may include a temporal indication. It may be determined whether to use parameters of the previous picture. Based on the determination of whether to use the parameters of the previous picture, it may be determined (e.g., may further be determined) whether the to use the prior entropy model or the updated entropy model. The temporal indication may be set based on whether it is associated with the updated entropy model or the prior entropy model. In examples, the entropy model indication(s) may include a replacement indication. The encoder may determine whether to use an updated entropy model or a learned entropy model. The replacement indication may be encoded based on whether it is determines to use the updated entropy model or the learned entropy model (e.g., associated with learned entropy model parameters) for the current picture.

Like encoding, the decoder may obtain the parameters of the previously encoded picture in advance and may reorder PMF tables for a factorized entropy model. The decoder may take a bitstream in baseline method (lb) and its corresponded additional bitstreams (pb).

The decoder may obtain an entropy model indication in video data. Based on the entropy model indication, the decoder may determine the between an updated entropy model and a prior entropy model. In examples, the prior entropy model may be or may include a learned entropy model. In examples, the prior entropy model may be or may include an entropy model used for encoding a previous picture (e.g., the picture preceding the current picture). In this case, these may be two possibilities: the previously decoded picture parameter may be none; or the previously decoded picture may be not be none. If the previously decoded picture parameter is none, there may be no previous picture available (e.g., the current picture may be the first picture in the video) or the previous picture may not be updated, meaning the learned entropy model may be used. If the previously decoded picture parameter is not none, then the decoder may use the parameter of the previously decoded picture. If the decoded indication (e.g., temporal indication) indicates an updated entropy model is used (e.g., the indication is 0), there may be no temporal redundancy between the parameters of the current frame and the previously decoded picture. Thus, one more indication may be read to check the replacement indication. If the replacement indication is 0, the decoder may determine to use the learned entropy model. If the replacement indication is 1, parameters may be read from the bitstream. The decoder may generate an updated entropy model based on the updated entropy model parameters. An example decoding schema for factorized entropy model's baseline bitstream and the additional bitstream is shown below in Algorithm 4:

```
Algorithm 4 Decoding with Factorized Entropy
  Input: Learned pmfs \hat{p}_{Ψ}^{(c)} for c = 1 . . . s, number of mixture K, previous
  interframe's params \hat{β}ₚ*^{(c)} for c = 1 . . . s, bitstreams lb and pb.
  Output: Latents ŷ ∈ [symbol]   ^{m×m×s}.
  Reorder \hat{p}_{Ψ}^{(c)} for c = 1 . . . s w.r.t its entropy
  for c = 1 to S do
    if pb.read( ) then
      if \hat{β}ₚ*^{(c)} = None then
        \hat{z}_{:,c} = lb.read(\hat{p}_{Ψ}^{(c)}) // read latent w.r.t learned pmf
      else
        \hat{z}_{:,c} = lb.read(\tilde{p}(.; \hat{β}ₚ*^{(c)})) / read latent w.r.t previous pmf
      end if
    else if pb.read( ) then
      \hat{β}*^{(c)} = pb.read( ) // read parameters
      \hat{z}_{:,c} = lb.read(\tilde{p}(.; \hat{β}ₚ*^{(c)})) // read latent w.r.t new pmt
    else
      \hat{z}_{:,c} = lb.read(\hat{p}_{Ψ}^{(c)}) / read latent w.r.t learned pmf
    end if
  end for
  for c = S + 1 to s do
    \hat{z}_{:,c} = lb.read(\hat{p}_{Ψ}^{(c)}) // read latent w.r.t learned pmf
  end for
```

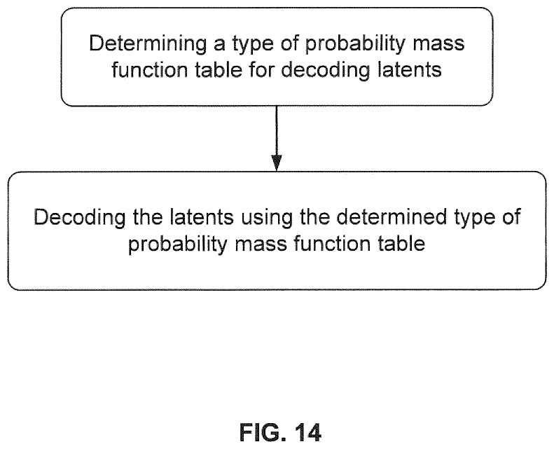

FIG. 14 illustrates an example for decoding for factorized entropy (e.g., which may apply to Algorithm 4 above). FIG. 14 shows an example of determining a type of entropy model for decoding latents (e.g., associated with parameters) of the entropy model of the current picture based on one or more indications. A latent representation of the current picture (e.g., latents associated with the current picture) may be decoded using the determined type of entropy model. In examples, the one or more indications may include a temporal indication. Whether to use the prior entropy model or the updated entropy model may be determined based on the temporal indication. Whether to replace a learned entropy model with an updated entropy model for decoding the current picture based on the replacement indication. Based on the determination to use the updated entropy model, entropy model parameters associated with the updated entropy model may be obtained.

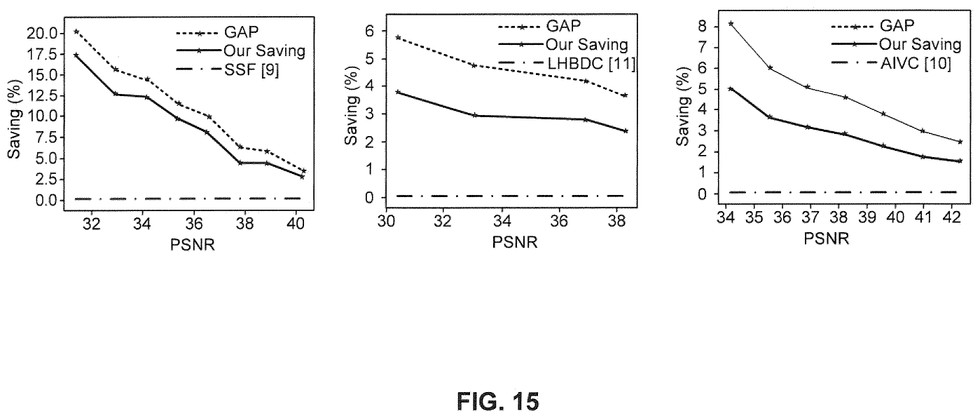

FIG. 15 illustrates an example of amortization gaps and savings relative to the total file size of three other neural video compression examples for a 16 frame length video sequence compression on 7 videos in a UVG dataset under a different reconstruction quality.

Table 2 shows a ratio of an amount of certain information in the bitstream, its amortization gap, and savings for different frame types and a 16 length sequence of video. Numbers (e.g., all numbers) may be indicated as a percentage and obtained by average results of 7 videos in a UVG test video set. Examples may be tested for the provided lowest bit rate. Table 2 is shown below:

| | | Motion Information | | | | | | Residual Information | | | | | | | |
|---|---|---|---|---|---|---|---|---|---|---|---|---|---|---|---|
| | | Factorized Entropy (Side) | | | Hyperprior Entropy (Main) | | | Factorized Entropy (Side) | | | Hyperprior Entropy (Main) | | | All | |
| Method | Frame | Ratio | Gap | Saving | Ratio | Gap | Saving | Ratio | Gap | Saving | Ratio | Gap | Saving | Gap | Saving |
| SSF | I | — | — | — | — | — | — | 19.8 | 36.5 | 30.2 | 80.2 | 10.2 | 3.4 | 15.4 | 8.7 |
| | P | 9.4 | 71.2 | 62.4 | 1.9 | 7.5 | 1.4 | 24.4 | 53.3 | 48.6 | 64.3 | 1.2 | 0.5 | 20.6 | 18.1 |
| | Video | 8.6 | 71.2 | 62.4 | 1.7 | 7.5 | 1.4 | 24.1 | 52.1 | 47.4 | 65.6 | 2.08 | 0.8 | 20.2 | 17.3 |
| LHBDC | I | — | — | — | — | — | — | 10.2 | 14.7 | 11.1 | 89.8 | 1.3 | 0.8 | 2.7 | 1.9 |
| | B | 0.4 | 18.0 | 1.6 | 3.5 | 12.0 | 1.9 | 13.2 | 43.9 | 37.2 | 82.9 | 2.6 | 0.8 | 8.3 | 5.6 |
| | Video | 0.2 | 18.0 | 1.6 | 2.1 | 12.0 | 1.9 | 12.2 | 33.6 | 27.9 | 85.5 | 2.0 | 0.8 | 6.1 | 4.1 |
| AIVC | I | 3.5 | 32.7 | 20.0 | 0.4 | 17.5 | 0.0 | 6.2 | 38.5 | 34.1 | 93.8 | 1.6 | 0.6 | 3.8 | 2.7 |
| | P | 3.9 | 38.5 | 19.3 | 0.1 | 26.0 | 0.0 | 8.2 | 25.1 | 18.3 | 87.9 | 2.3 | 1.0 | 5.3 | 3.0 |
| | B | | | | | | | 14.9 | 40.9 | 27.7 | 81.1 | 4.3 | 2.2 | 11.1 | 6.6 |
| | Video | 2.4 | 37.5 | 19.4 | 0.1 | 22.7 | 0.0 | 10.8 | 39.0 | 28.2 | 86.7 | 2.9 | 1.4 | 7.7 | 4.7 |

7 video sequences may be used on UVG dataset, which may each have 1080p resolution. The first 16 frames of each sequence may be used and may be compressed by SSF, LHBDC, and AIVC. SSF may encode the first frame as an l frame and rest of the 15 frames as P frames. LHBDC may need 2 reference frames (e.g., for example, the first frame and 17th frame is l frame and all 15 frames in between frames are B frames). In calculations, the count 17th frame may be not counted, thus may (e.g., may also) be the next GOP's first reference frame and may be accounted in the next GOP's file size. AIVC may encode the first frame as l frame, 16th frame as P frames, and the rest of 14 frames as B frames. In order to give detailed gap sources of the model's for different frame types and different information, the result may be given on Table 1 for lowest bpp objective. The ratio of the amount of certain information with respect to the total file size of certain frame type may also be provided. According to table 2, information may come from the residual's main information. Side information gaps may be way bigger than main information gaps in both motion and residual information. The examples herein may perform quite well on factorized entropy. In average of 16 frame length sequences, 20.2% of the gap may be measured in SSF and gaps (e.g., mostly all gaps) may be closed and the file size may be decreased 17.3%. In LHBDC, the gap and performance may be better on B frames but in average in the video, the gap may become 6.1% and 5.6% of the file size may be saved (e.g., without any effect on reconstruction). AIVC's B frame gap (11.1%) and the performance (6.6%) may be quite well, but in the video found, the gap may be 7.7% and file size may be 4.7% smaller.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-31. (canceled)

32. A device for video decoding, comprising:
a processor configured to:
obtain an entropy model indication for decoding a current picture;
obtain an entropy model based on the entropy model indication; and
decode the current picture based on the entropy model.

33. The device of claim 32, wherein the processor is further configured to:
based on the entropy model indication indicating to use a reparametrized entropy model for decoding the current picture, obtain the reparametrized entropy model, wherein the current picture is decoded based on the reparametrized entropy model.

34. The device of claim 32, wherein the processor is further configured to:
based on the entropy model indication indicating to use a reparametrized entropy model for decoding the current picture, obtain at least one updated entropy model parameter associated with the reparametrized entropy model, wherein the current picture is decoded based on the at least one updated entropy model parameter associated with the reparametrized entropy model.

35. The device of claim 32, wherein the processor is further configured to:
based on the entropy model indication indicating to use a prior entropy model for decoding the current picture, obtain the prior entropy model, wherein the current picture is decoded based on the prior entropy model.

36. The device of claim 32, wherein the processor is further configured to:
based on the entropy model indication indicating to use a learned entropy model for decoding the current picture, obtain the learned entropy model, wherein the current picture is decoded based on the learned entropy model.

37. The device of claim 32, wherein the processor is further configured to:
based on the entropy model indication indicating to use a prior entropy model for decoding the current picture, obtain previous entropy model parameters associated with a previous picture, wherein the current picture is decoded based on the previous entropy model parameters associated with the previous picture.

38. A method for video decoding, the method comprising:
obtaining an entropy model indication for decoding a current picture;
obtaining an entropy model based on the entropy model indication; and
decoding the current picture based on the entropy model.

39. The method of claim 38, further comprising:
based on the entropy model indication indicating to use a reparametrized entropy model for decoding the current picture, obtaining the reparametrized entropy model, wherein the current picture is decoded based on the reparametrized entropy model.

40. The method of claim 38, further comprising:
based on the entropy model indication indicating to use a reparametrized entropy model for decoding the current picture, obtaining at least one updated entropy model parameter associated with the reparametrized entropy model, wherein the current picture is decoded based on the at least one updated entropy model parameter associated with the reparametrized entropy model.

41. The method of claim 38, further comprising:
based on the entropy model indication indicating to use a prior entropy model for decoding the current picture, obtaining the prior entropy model, wherein the current picture is decoded based on the prior entropy model.

42. The method of claim 38, further comprising:
based on the entropy model indication indicating to use a learned entropy model for decoding the current picture, obtaining the learned entropy model, wherein the current picture is decoded based on the learned entropy model.

43. The method of claim 38, further comprising:
based on the entropy model indication indicating to use a prior entropy model for decoding the current picture, obtaining previous entropy model parameters associated with a previous picture, wherein the current picture is decoded based on the previous entropy model parameters associated with the previous picture.

44. A device for video encoding, comprising:
a processor configured to:
determine an entropy model for encoding a current picture;
encode the current picture based on the determined entropy model; and
include an indication of the determined entropy model in video data.

45. The device of claim 44, wherein the processor is further configured to:
based on determining to use a reparametrized entropy model for encoding the current picture, set the indication of the determined entropy model to indicate that the reparametrized entropy model is used for the current picture.

46. The device of claim 44, wherein the processor is further configured to:
based on determining to use a reparametrized entropy model for encoding the current picture, set the indication of the determined entropy model to indicate that the reparametrized entropy model is used for the current picture; and
include an indication of at least one updated entropy model parameter associated with the reparametrized entropy model in the video data.

47. The device of claim 44, wherein the processor is further configured to:
obtain a latent representation of the current picture;
derive a reparametrized entropy model based on the latent representation; and
determine to use the reparametrized entropy model for encoding the current picture.

48. The device of claim 47, wherein the reparametrized entropy model comprises updated entropy model parameters, and wherein the processor is further configured to:
quantize the updated entropy model parameters based on the derivation of the reparametrized entropy model; and
calculate a gain associated with using the updated entropy model parameters and a cost associated with indicating the updated entropy model parameters in the video data.

49. The device of claim 44, wherein the processor is further configured to:
based on determining to use a learned entropy model for encoding the current picture, set the indication of the determined entropy model to indicate that the learned entropy model is used for the current picture.
